(19) United States
(12) Patent Application Publication
(10) Pub. No.: US 2004/0223319 A1
(43) Pub. Date: Nov. 11, 2004

(54) Back light module

(76) Inventors: Hui-Kai Chou, Taipei City (TW); Yi-Shiuan Tsai, Kaohsiung (TW)

Correspondence Address: J.C Patents, Inc., 4 Venture, Suite 250, Irvine, CA, 92618, US

(21) Appl. No.: 10/606,376

(22) Filed: Jun. 24, 2003

(30) Foreign Application Priority Data
May 7, 2003 (TW) 92112400

(51) Int. Cl. G09F 13/04; F21V 7/10

(52) U.S. Cl. 362/97; 362/216; 362/252; 362/260

(57) ABSTRACT

A back light module is provided. The back light module comprises a frame, a U-shaped lamp tube and a diffusion plate. The U-shaped lamp tube is set inside the frame. The U-shaped lamp has two electrodes that face the bottom section of the frame just underneath the lamp tube. The diffusion plate is also set inside the frame above the U-shaped lamp tube. Since the U-shaped lamp tube forms the light source of the back light module, the number of light tubes is only half of that of the conventional back light module having straight lamp tubes and hence the light energy required to illuminate the module is effectively reduced.

### CROSS-REFERENCE TO RELATED APPLICATION

This application claims the priority benefit of Taiwan application serial no. 92112400, filed MAY 7, 2003.

### BACKGROUND OF THE INVENTION

1. Field of the Invention

The present invention genrally relates to a back light module, and more particularly relates to a back light module requiring a smaller number of lamp tubes and consume lesser amount of energy.

2. Description of the Related Art

To match the modern life style, video or imaging device needs to be lighter and slimmer. Although the conventional cathode ray tube (CRT) display has many advantages, the design of the electron gun renders it heavy and bulky. Moreover, there is always some risk of hurting viewer's eyes due to emitted radiation. With big leaps in the techniques in manufacturing semiconductor devices and electro-optical devices, flat panel displays such as liquid crystal displays (LCD), organic light-emitting displays (OLED) and plasma display panel (PDP) have gradually become mainstream display products.

According to the light source, a liquid crystal display can be classified as belonging to one of the three types, namely a reflection LCD, a transmissive LCD and a transflective LCD. Using a transmission or a transflective LCD as an example, the LCD mainly comprises a liquid crystal panel and a back light module. The liquid crystal panel furthermore comprises a liquid crystal layer sandwiched between two transparent substrates. The back light module provides a plane light source to illuminate the liquid crystal panel for displaying images.

FIG. 1 is a schematic cross-sectional view of a conventional back light module. FIG. 2 is a schematic cross-sectional view along a perpendicular direction to the back light module of FIG. 1. As shown in FIGS. 1 and 2, the back light module 100 mainly comprises a frame 102, a reflecting plate 104, at least a straight lamp tube 106, a diffusion plate 108 and a plurality of optical films 110. The reflecting plate 104 is formed on the bottom section of the frame 102. The straight lamp tubes 106 are positioned inside the frame 102 above the reflecting plate 104. Furthermore, the diffusion plate 108 is set on the frame 102 above the straight lamp tubes 106 and the optical films 110 are formed on the diffusion plate 108.

The aforementioned back light module 100 is a down-projecting type back light module for a liquid crystal display. At present, liquid crystal displays are commonly used in small dimensional panels such as mobile phones or personal digital assistant (PDA). However, the current trend is aiming towards the production of liquid crystal display with a larger dimension. For the down-projecting type of liquid crystal display, longer lamp tubes must be used as the dimension of the liquid crystal display is increased. During transportation or assembly, the lamp tubes are liable to break or crack due to its length. Since the lamp tubes have no standard dimensions, they must be specially produced leading to a higher production cost. Furthermore, the number of lamp tubes must also be increased in order to maintain a constant illumination when the display panel is larger. However, an increased number of lamp tubes consume increased amount of electrical power iunder normal operation.

### SUMMARY OF THE INVENTION

Accordingly, one object of the present invention is to provide a back light module having U-shaped lamp tubes instead of straight lamp tubes so that the number of lamp tubes inside the back light module can be reduced to decrease overall power consumption.

A second object of this invention is to provide a back light module having U-shaped lamp tubes instead of straight lamp tubes so that overall production (or purchase) cost of the lamp tubes is reduced.

To achieve these and other advantages and in accordance with the purpose of the invention, as embodied and broadly described herein, the invention provides a back light module. The back light module comprises a frame, a U-shaped lamp tube and a diffusion plate. The U-shaped lamp tube is positioned inside the frame with the electrodes of the U-shaped lamp tube facing the bottom section of the frame just underneath the U-shaped lamp tube. In addition, the diffusion plate is positioned inside the frame above the U-shaped lamp tube.

This invention also provides an alternative type of back light module. The back light module comprises a frame, at least a lamp tube module and a diffusion plate. The lamp tube module includes at least two U-shaped lamp tubes positioned inside the frame with the electrodes of the U-shaped lamp tubes facing the section of the frame just underneath the U-shaped lamp tubes or facing the lateral side of the frame. In addition, the diffusion plate is positioned inside the frame above the U-shaped lamp tubes.

In this invention, U-shaped lamp tubes replaces the conventional straight lamp tubes. Hence, only half the number of lamp tubes is required to illuminate a display of a given dimension. In other words, using the U-shaped lamp tubes is able to reduce not only the power consumption but also the cost of producing the display.

Furthermore, by bending the electrodes of the U-shaped lamp tubes towards the frame underneath the lamp tube facilitates the removal of heat generated by the lamp tubes and hence prevents the heat from reaching the display panel which would otherwise have adverse effects on its display performance.

In addition, more than one module of U-shaped lamp tubes may be installed inside the frame. These modules of U-shaped lamp tubes can be positioned inside the frame in a multitude of designs so that it is possible to replace each of the damaged lamp tubes individually.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic cross-sectional view of a conventional back light module.

FIG. 2 is a schematic cross-sectional view along a perpendicular direction to the back light module shown in FIG. 1.

FIG. 3 is a schematic cross-sectional view of a back light module according to a first preferred embodiment of this invention.

FIG. 4 is a schematic cross-sectional view along a perpendicular direction to the back light module shown in FIG. 3.

FIG. 5 is a top view of the back light module shown in FIG. 3.

FIG. 6 is a schematic cross-sectional view of a back light module according to a second preferred embodiment of this invention.

FIG. 7 is a schematic cross-sectional view along a perpendicular direction to the back light module shown in FIG. 6.

FIG. 8 is a top view of the back light module shown in FIG. 6.

FIG. 9 is a schematic cross-sectional view of a back light module according to a third preferred embodiment of this invention.

FIGS. 10 to 19 are a series of top views showing a few arrangements of U-shaped lamp tubes inside the lamp tube modules according to this invention.

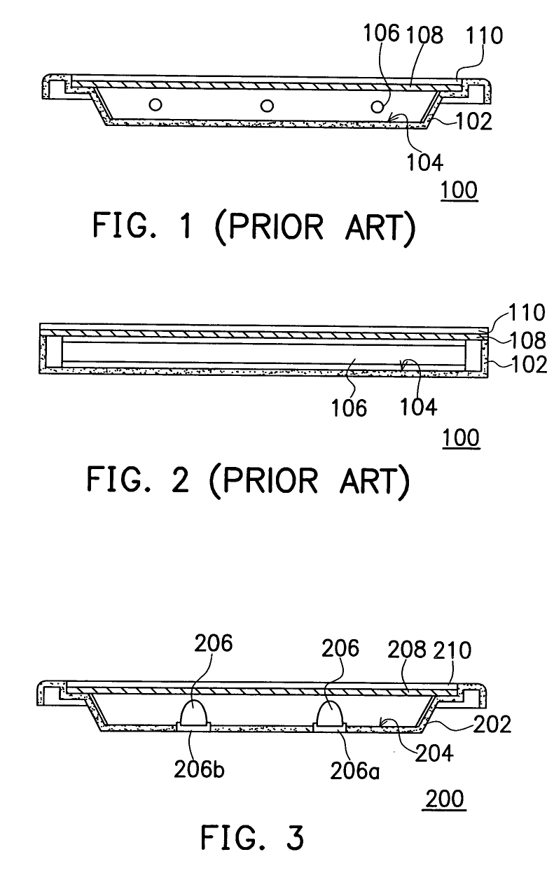

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

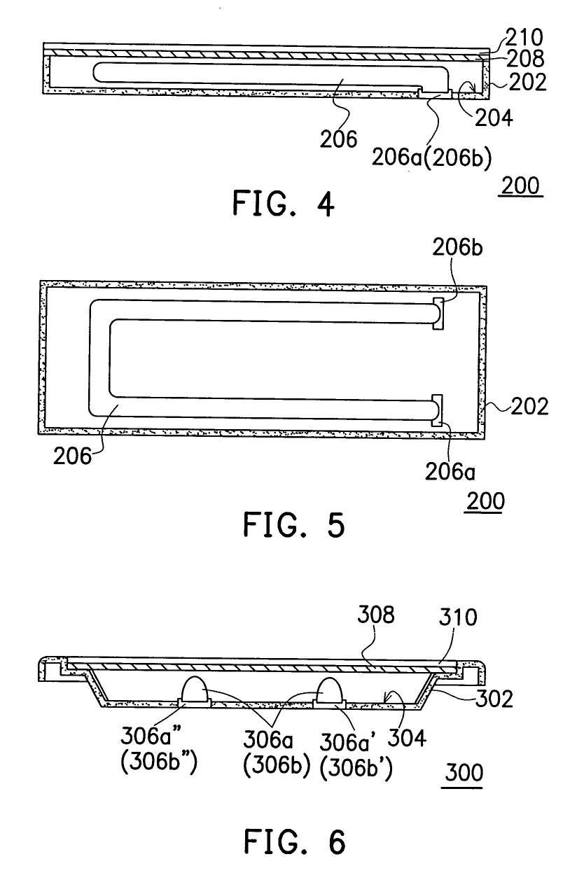

FIG. 3 is a schematic cross-sectional view of a back light module according to a first preferred embodiment of this invention. FIG. 4 is a schematic cross-sectional view along a perpendicular direction to the back light module shown in FIG. 3. FIG. 5 is a top view of the back light module shown in FIG. 3. As shown in FIGS. 3, 4 and 5, the back light module 200 comprises a frame 202, a U-shaped lamp tube 206 and a diffusion plate 208. The U-shaped lamp tube 206 is set inside the frame 202. The two electrodes (206a and 206b) of the U-shaped lamp tube 206 face the bottom section of the frame 202 just underneath the U-shaped lamp tube 206.

The diffusion plate 208 is also set inside the frame 202 above the U-shaped lamp tube 206. The diffusion plate 208 is fabricated using a film of material including, for example, acrylic resin or polycarbonate. When light emitted directly from a light source or indirectly from the light source after a reflection is passed through the diffusion plate 208, a plane light radiation will emerge from the diffusion plate.

The back light module 200 also comprises a reflecting plate 204 set at the bottom section of the frame 202. The reflecting plate 204 deflects the light from the lamp tube 206 and not directed towards the display panel (not shown) so that percentage utilization of light from the lamp tube 206 is increased. In addition, a plurality of optical plates 210 is also set over the diffusion plate 208. The optical plates 210 are light-enhancing plates or prism plates, for example. The optical plates 210 allow concentration of most of the light passing through the diffusion plate 208 into the liquid crystal panel, thereby increasing the overall utilization of light energy emitted by the lamp tube 206.

In this invention, the electrodes 206a, 206b of the U-shaped lamp tube 206 are positioned to face the bottom section of the frame just underneath the lamp tube 206. This type of arrangement has several advantages. In general, an inverter is connected to one of the two electrodes of a lamp tube so that the two inverters can be connected together through a signal controlling signal line. Further, since the two electrodes of a U-shaped lamp tube are quite close to each other and face the bottom section of the frame, and therefore the overall length of the signal controlling line between the two inverters can be substantially reduced or eliminated altogether.

In addition, by positioning the electrodes of the U-shaped lamp tube towards the frame underneath the lamp tube also prevents the transfer of heat towards the display panel, which would otherwise adversely affect its performance.

Aside from forming a back light module with a U-shaped lamp tube, this invention also provides the concept of building a light module comprising an assembly of a plurality of lamp tubes.

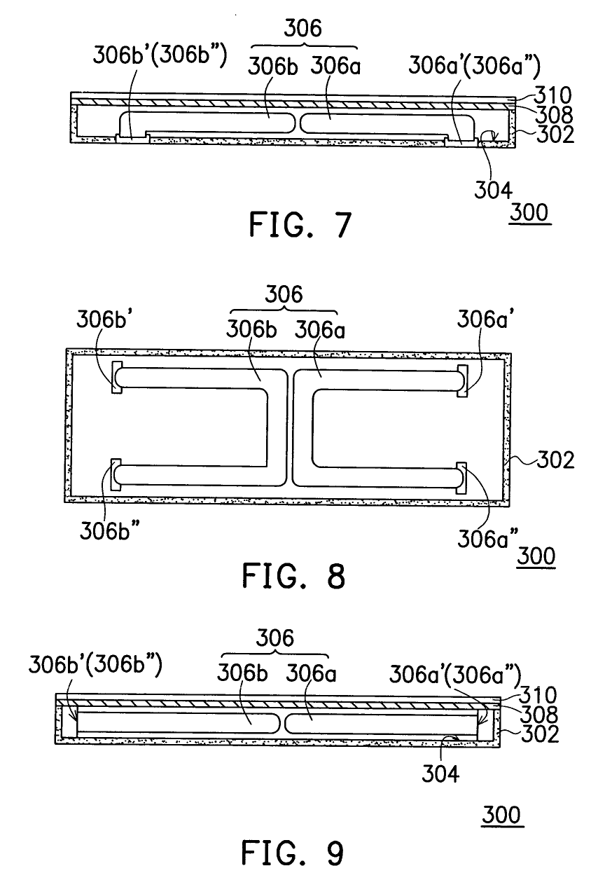

FIG. 6 is a schematic cross-sectional view of a back light module according to a second preferred embodiment of this invention. FIG. 7 is a schematic cross-sectional view along a perpendicular direction to the back light module shown in FIG. 6. FIG. 8 is a top view of the back light module in FIG. 6. As shown in FIGS. 6, 7 and 8, the back light module 300 comprises a frame 302, a lamp tube module 306 and a diffusion plate 308. The lamp tube module 306 having at least two U-shaped lamp tubes (306a and 306b) are set inside the frame 302. The electrodes (306a′, 306a″ and 306b′, 306b″) of the U-shaped lamp tubes (306a and 306b) face the bottom section of the frame 302 just underneath the lamp tube module 306, for example. Obviously, the two electrodes of the U-shaped lamp tubes face the lateral side of the frame. As shown in FIG. 9, the electrodes (306a′, 306a″ and 306b′, 306b″) of the U-shaped lamp tubes (306a and 306b) face the sides of the frame 302.

The diffusion plate 308 is set inside the frame 302 above the U-shaped lamp tube 306. The diffusion plate 308 is fabricated using a film of material including, for example, acrylic resin or polycarbonate. When light emitted directly from a light source or indirectly from the light source after a reflection is passed through the diffusion plate 308, a planar light source will emerge from the diffusion plate.

The back light module 300 comprises a reflecting plate 304 set at the bottom section of the frame 302. The reflecting plate 304 deflects the light from the group of lamp tubes 306 and not directed towards the display panel (not shown) so that percentage utilization of light energy from the lamp tubes (306a and 306b) can be substantially increased. In addition, a plurality of optical plates 310 is also set over the diffusion plate 308. The optical plates 310 are light-enhancing plates or prism plates, for example. The optical plates 310 are capable of concentrating most of the light energy passing through the diffusion plate 308 into the liquid crystal panel, thereby increasing the overall light utilization of the lamp tubes 306.

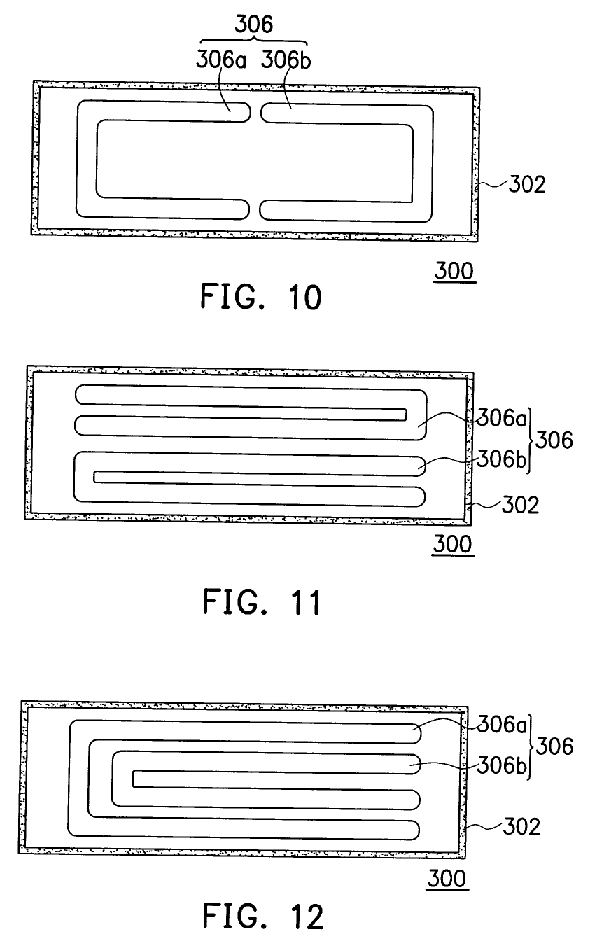

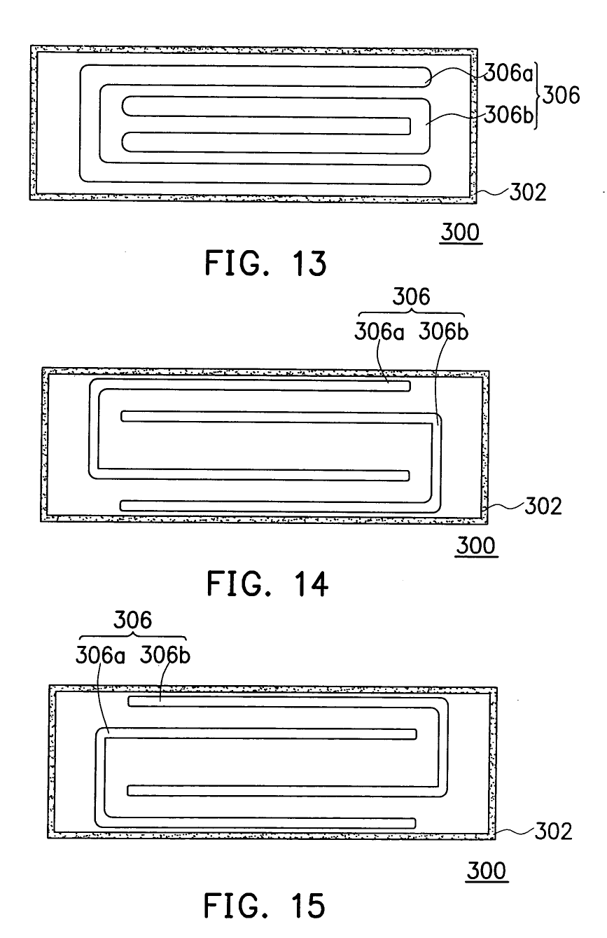

It is to be noted that the two U-shaped lamp tubes (306a and 306b) of the lamp tube module 306 are positioned symmetrically inside the frame 302. However, the layout of the U-shaped lamp tubes as shown in FIG. 8 is not the only possible symmetrical arrangement. Some other positioning patterns for the U-shaped lamp tubes (306a and 306b) that also have a symmetrical configuration are also shown in FIGS. 10 to 13.

It is to be further noted that if the open end of the U-shaped lamp tubes (306a and 306b) face the side of the frame 302 or the layout of the U-shaped lamp tubes (306a and 306b) permit the electrodes to attach to the side of the frame 302, the electrodes (306a′, 306a″ and 306b′, 306b″) of the U-shaped lamp tubes (306a and 306b) may face the bottom section of the frame 302 just underneath the lamp tube module 306 or the side of the frame 302 selectively. On the contrary, if the open end of the U-shaped lamp tubes (306a and 306b) is away from the side of the frame 302 or the layout of the U-shaped lamp tubes (306a and 306b) does not permit the electrodes to attach to the side of the frame 302, the electrodes (306a′, 306a″ and 306b′, 306b″) of the U-shaped lamp tubes (306a and 306b) have no choice but to face the bottom section of the frame 302 just underneath the lamp tube module 306.

Aside from symmetrical positioning, the U-shaped lamp tubes (306a and 306b) in each module 306 may alternate with each other as shown in FIGS. 14 and 15. Similarly, the electrodes (306a′, 306a″ and 306b′, 306b″) of the U-shaped lamp tubes (306a and 306b) may face the bottom section of the frame 302 just underneath the lamp tube module 306 or the side of the frame 302 selectively. In other words, the positioning of the electrodes of the U-shaped lamp tubes (306a and 306b) depend on the layout of the U-shaped lamp tubes.

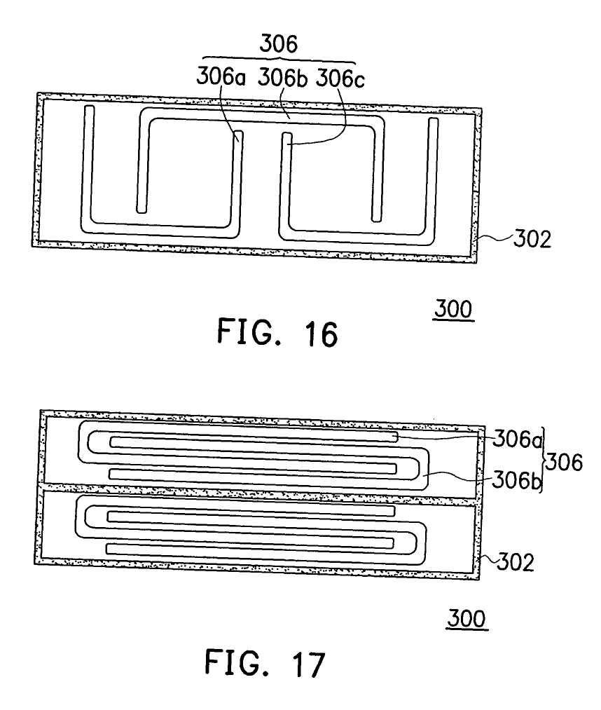

Furthermore, the number of U-shaped lamp tubes in each lamp tube module 306 is not limited to two (306a and 306b) as shown in FIG. 16. As shown in FIG. 16, the back light module 300 comprises three alternately positioned U-shaped lamp tubes (306a, 306b and 306c). In other words, the number of U-shaped lamp tubes inside the back light module 300 can be any number according to user's requirement.

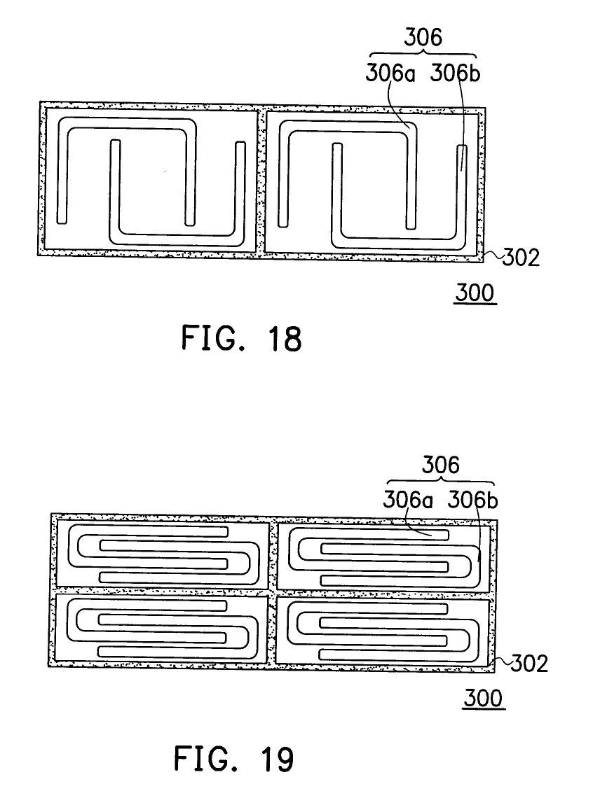

In addition, this invention also permits the incorporation of more than one lamp tube modules inside the back light module based on the display panel requirements as shown in FIGS. 17 to 19. The layout of the lamp tube modules 306 may be in rows (as shown in FIG. 17), in columns (as shown in FIG. 18) or in a matrix form (as shown in FIG. 19) arranged in a plurality of rows and a plurality of columns. However it is to be noted that in the aforementioned arrangements, each lamp tube module 306 may comprise a pair of symmetrically positioned or alternately positioned U-shaped lamp tubes. Furthermore, three or more alternately positioned U-shaped lamp tubes in each lamp tube module 306 is also permitted.

Obviously, the number and layout of the U-shaped lamp tubes inside each lamp tube module and the arrangement thereof can be various. Hence, the number and layout of the U-shaped lamp tubes in the aforementioned illustration should by no means limit the scope of this invention.

In this invention, U-shaped lamp tubes replace the conventional straight lamp tubes. Hence, only half the number of lamp tubes is required to illuminate a display of a given dimension. In other words, using the U-shaped lamp tubes is able to reduce not only the power consumption but also the cost of producing the display. Moreover, U-shaped lamp tubes are less vulnerable to vibration. Thus, damages resulting during assembly or transportation are greatly reduced.

The electrodes of the U-shaped lamp tubes may also be bent to face the bottom section of the frame just underneath the lamp tube so that the heat is conducted away from the display panel to prevent its effect on performance.

More than one group of U-shaped lamp tubes or lamp tube modules may be installed inside the frame. These lamp tube modules can be positioned inside the frame in a multitude of ways and hence increasing the number of possible design choices. Moreover, each damaged lamp tube module can be replaced individually.

Since the electrodes at the end of the U-shaped lamp tubes can be set to face the side of the frame or the bottom section of the frame, a suitable configuration for a particular set of design criteria is often found. In addition, aside from acting as a back light module for a liquid crystal display, the back light module of this invention can be applied to other types of display requiring back light illumination.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A back light module, comprising:
a frame;
at least a U-shaped lamp tube positioned inside the frame, wherein the U-shaped lamp tube has two electrodes that faces the bottom section of the frame just underneath the U-shaped lamp tube; and
a diffusion plate positioned inside the frame above the U-shaped lamp tube.

2. The back light module of claim 1, wherein the module furthermore comprises a reflecting plate set on the bottom section of the frame.

3. The back light module of claim 1, wherein the module furthermore comprises a plurality of optical plates positioned over the diffusion plate.

4. A back light module, comprising:
a frame;
at least a lamp tube module positioned inside the frame, wherein each lamp tube module comprises at least two U-shaped lamp tubes; and
a diffusion plate positioned inside the frame above said lamp tubes.

5. The back light module of claim 4, wherein the electrodes of the U-shaped lamp tube inside each lamp tube module face the bottom section of the frame just underneath the lamp tubes.

6. The back light module of claim 4, wherein the electrodes of the U-shaped lamp tube inside each lamp tube module face one of the side edges of the frame.

7. The back light module of claim 4, wherein the U-shaped lamp tubes within each lamp tube module is symmetrically positioned inside the frame.

8. The back light module of claim 4, wherein the U-shaped lamp tubes within each lamp tube module is alternately positioned inside the frame.

9. The back light module of claim 4, wherein the lamp tube modules form an array inside the frame.

10. The back light module of claim 4, wherein the lamp tube modules are laid down in rows or columns inside the frame.

11. The back light module of claim 4, wherein the module furthermore comprises a reflecting plate positioned on the bottom section of the frame.

12. The back light module of claim 4, wherein the module furthermore comprises a plurality of optical plates positioned on the diffusion plate.
